(19) United States
(12) Patent Application Publication
(10) Pub. No.: US 2026/0128059 A1
(43) Pub. Date: May 7, 2026

(54) Disk Drive Suspension Assembly With Base Plate For Improved Sway Frequency

(71) Applicant: Magnecomp Corporation, Murrieta, CA (US)

(72) Inventor: Kuen Chee Ee, Chino, CA (US)

(21) Appl. No.: 19/374,349

(22) Filed: Oct. 30, 2025

Related U.S. Application Data
(60) Provisional application No. 63/716,907, filed on Nov. 6, 2024.

(51) Int. Cl. G11B 5/48

(52) U.S. Cl. CPC G11B 5/4833; G11B 5/4826; G11B 5/4873

(57) ABSTRACT

A suspension assembly comprises a load beam including a proximal end terminating in a hinge, a gimbal assembly mounted to the load beam, a base plate, and PZT actuators. The base plate comprising a distal portion connected to the hinge, a proximal portion, and a neck portion disposed between the distal portion and the proximal portion, wherein the neck portion comprising side edges facing away from each other, wherein the side edges, the distal portion and the proximal portion define openings, wherein each of the side edges includes a protrusion at a center of the neck portion facing one of the openings. Each of the PZT actuators is disposed in one of the openings and mounted to the proximal portion and the distal portion.

### CROSS-REFERENCE TO RELATED APPLICATIONS

This application claims the benefit of, and priority to, U.S. Provisional Application No. 63/716,907 filed on Nov. 6, 2024, which is hereby incorporated by reference in its entirety.

### FIELD OF THE INVENTION

The present disclosure relates generally to suspension assemblies for supporting read/write heads over recording media in magnetic disk drive storage devices.

### BACKGROUND OF THE INVENTION

Storage devices such as magnetic disk drive storage devices (“disk drives”) store data on, and read data from, a spinning disk medium using a read/write head positioned over the surface of the spinning disk medium. A suspension assembly is used to position the read/write head over concentric tracks of the spinning disk medium. As an example, as shown in FIG. 1, a suspension assembly 2 can include a load beam 4 with a gimbal assembly 6 (containing a read/write head) mounted near the distal end of the load beam 4 that allows the read/write head to fly closely over the surface of the spinning disk medium during operation. The proximal end of the load beam 4 terminates in a hinge 8 that is connected to a distal portion 10a of a base plate 10. A proximal portion 10b of the base plate 10 is connected to an actuator arm 12, which is connected to an actuator motor (not shown) that rotates the actuator arm 12, thus moving the entire suspension assembly 2 relative to the spinning disk medium. During operation, the actuator motor is used to move the read/write head in a side-to-side direction, to position the read/write head over a desired concentric track of the spinning disk to write data to, or read data from, the desired concentric track.

As disk drive manufactures continue to develop smaller yet higher storage capacity drives, the density of the concentric tracks on the disk increases, making them narrower and more closely spaced. As track density increases, however, it becomes increasingly difficult for the actuator motor to quickly and accurately position the read/write head over the desired concentric track. Therefore, it has become known to use a pair of piezoelectric (PZT) actuators 14 mounted between the proximal portion 10b and distal portion 10a of the base plate 10 to move the position of the read/write head, as shown in FIG. 2. Specifically, the base plate 10 includes a neck portion 10c extending between, and having a smaller width than, the proximal portion 10b and distal portion 10a, defining openings 10d in which the PZT actuators 14 are mounted. The PZT actuators 14 expand and contract in response to electrical signals, to displace the distal portion 10a relative to the proximal portion 10b by flexing the neck portion 10c, which in turn displaces the read/write head located near the distal end of the load beam 4. Thus, higher track positioning resolution can be achieved by complimenting the course positioning of the read/write head by the actuator motor with the fine positioning of the read/write head by the PZT actuators 14.

In a disk drive suspension assembly, the “sway frequency” refers to the natural frequency at which the read/write head oscillates sideways, essentially a side-to-side vibration mode of the suspension assembly. Sway frequency is a key parameter indicating the stability and performance of the read/write head movement during data access. A higher sway frequency generally corresponds to better stability and performance. Another parameter of disk drive suspension assemblies is the total operational displacement of the distal portion 10a of base plate 10 caused by the expanding/contracting PZT actuators, which is also referred to as stroke sensitivity. A higher stroke sensitivity also generally corresponds to better stability and performance. However, design modifications to increase sway frequency can decrease stroke sensitivity, and vice versa. For example, increasing the width of neck portion 10c can increase the sway frequency, but will decrease stroke sensitivity.

There is a need to improve the performance of the fine positioning by the PZT actuators by increasing sway frequency with only a minimal impact on stroke sensitivity.

### BRIEF SUMMARY OF THE INVENTION

The aforementioned problems and needs are addressed by a suspension assembly comprising a load beam including a proximal end terminating in a hinge, a gimbal assembly mounted to the load beam, a base plate, and PZT actuators. The base plate comprises a distal portion connected to the hinge, a proximal portion, and a neck portion disposed between the distal portion and the proximal portion. The neck portion comprises side edges facing away from each other; and the side edges, the distal portion and the proximal portion define openings, and each of the side edges includes a protrusion at a center of the neck portion facing one of the openings. Each of the PZT actuators is disposed in one of the openings and mounted to the proximal portion and the distal portion.

In other embodiments, a suspension assembly comprises a load beam including a proximal end terminating in a hinge, a gimbal assembly mounted to the load beam, a base plate and PZT actuators. The base plate comprises a distal portion connected to the hinge, a proximal portion, and a neck portion disposed between the distal portion and the proximal portion. The neck portion comprises side edges facing away from each other; and the side edges, the distal portion and the proximal portion define openings, and the distal portion includes a distal edge facing away from the proximal portion, and the distal edge includes a notch. Each of the PZT actuators is disposed in one of the openings and mounted to the proximal portion and the distal portion.

Other objects and features of the present disclosure will become apparent by a review of the specification, claims and appended figures.

### BRIEF DESCRIPTION OF THE DRAWINGS

Embodiments of the present invention are illustrated by way of example and not limitation in the figures of the accompanying drawings, in which like references indicate similar elements and in which:

FIG. 1 is a perspective view of a conventional suspension assembly.

FIG. 2 is a top view of a conventional suspension assembly.

FIG. 3 is top view of a suspension assembly according to a first example.

FIG. 4 is a top view of the base plate shown in FIG. 3 according to the first example.

FIG. 5 is a top view of a base plate according to a second example.

FIG. 6 is a top perspective view of a base plate according to a third example.

FIG. 7 is a top perspective view of a base plate according to a fourth example.

FIG. 8 is a top view of a base plate according to a fifth example.

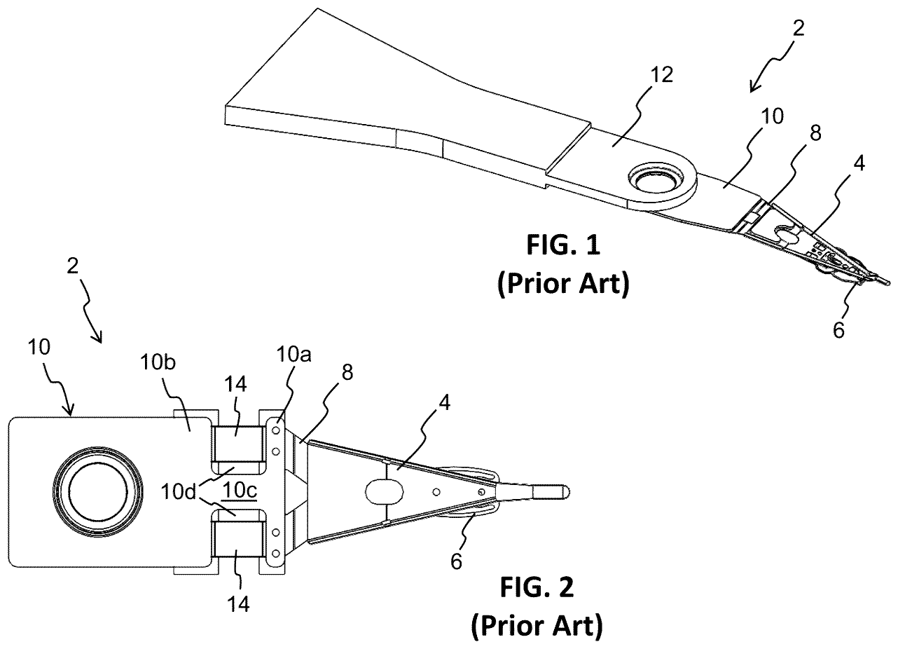

### DETAILED DESCRIPTION OF THE INVENTION

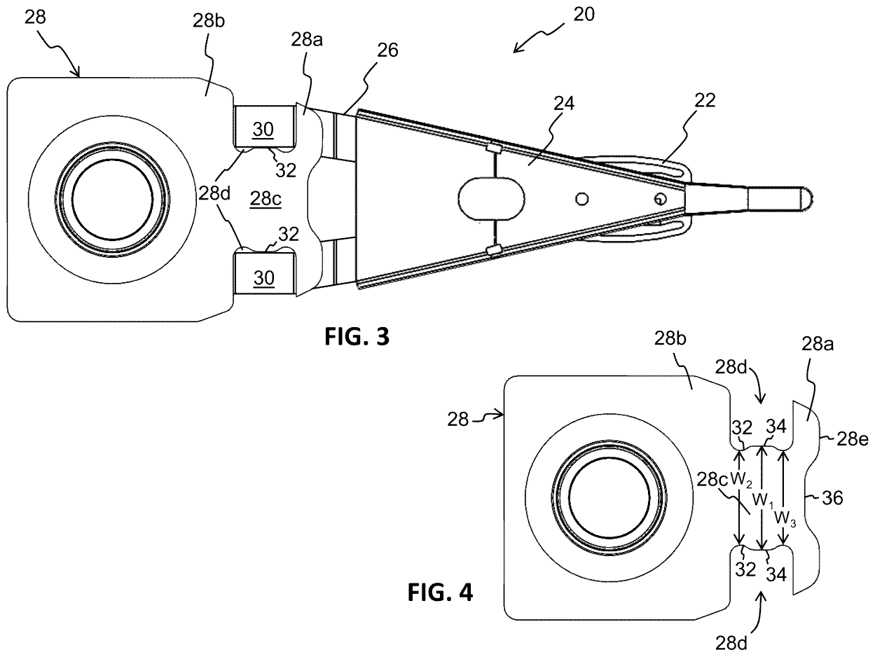

The present disclosure is directed a disk drive suspension assembly 20 that provides improved sway frequency. The suspension assembly 20 is shown in FIG. 3. A gimbal assembly 22 (containing a read/write head) is mounted near a distal end of a load beam 24. The proximal end of the load beam 24 terminates in a hinge 26 that is connected to the distal portion 28a of a base plate 28. The hinge 26 allows the load beam 24 to move vertically (i.e., toward and away from a spinning disk, not shown) during operation relative to the base plate 28. The proximal portion 28b of the base plate 28 is connected to an actuator arm (not shown), which in turn is connected to an actuator motor (not shown) which used to move the suspension assembly 20 side-to-side to position the read/write head of the gimbal assembly 22 over the desired concentric track on the surface of the spinning disk.

As best shown in FIG. 4, the base plate 28 includes a neck portion 28c extending between, and having a smaller width than, the proximal portion 28b and distal portion 28a. The neck portion 28c includes side edges 32 that face away from each other. The side edges 32, the proximal portion 28b and the distal portion 28a define two openings 28d in which two PZT actuators 30 are mounted. Specifically, each PZT actuator 30 is disposed in one of the openings 28d and is mounted to the proximal portion 28b and the distal portion 28a.

Each side edge 32 of neck portion 28c includes a protrusion 34 at a center of the neck portion 28c and facing one of the openings 28d, so that the neck portion 28c includes a first width W₁ at a center of the neck portion, a second width W₂ adjacent the proximal portion 28b, and a third width W₃ adjacent the distal portion 28a, where the first width W₁ is greater than the second width W₂ and the third width W₃. The distal portion 28a of the base plate 28 includes a distal edge 28e (facing away from the proximal portion 28b of base plate 28). The distal edge 28e can include a notch 36.

Therefore, in comparison to conventional base plates, there is added base plate material to the neck portion 28c in the form of protrusions 34 on the opposing side edges 32, and there is omitted base plate material at the distal edge 28e of distal portion 28a. It has been discovered by the present inventor that this combination of changes (i.e., additional base plate material at a center portion of the neck portion 28c, and less base plate material at the distal edge 28e of the distal portion 28a) results in a meaningful increase in sway frequency, with only a modest decrease in stroke sensitivity, for improved performance. The protrusions 34 provide increased sway frequency, but the reduced second and third widths W₂, W₃ relative to first width W₁ provides better flexibility to avoid a significant decrease in stroke sensitivity that comes with the increased sway frequency. This improved performance can be enhanced even further by optionally bonding the protrusions 34 to the sides of the PZT actuators 30, which increases stiffness at a center of the neck portion 10c for better performance.

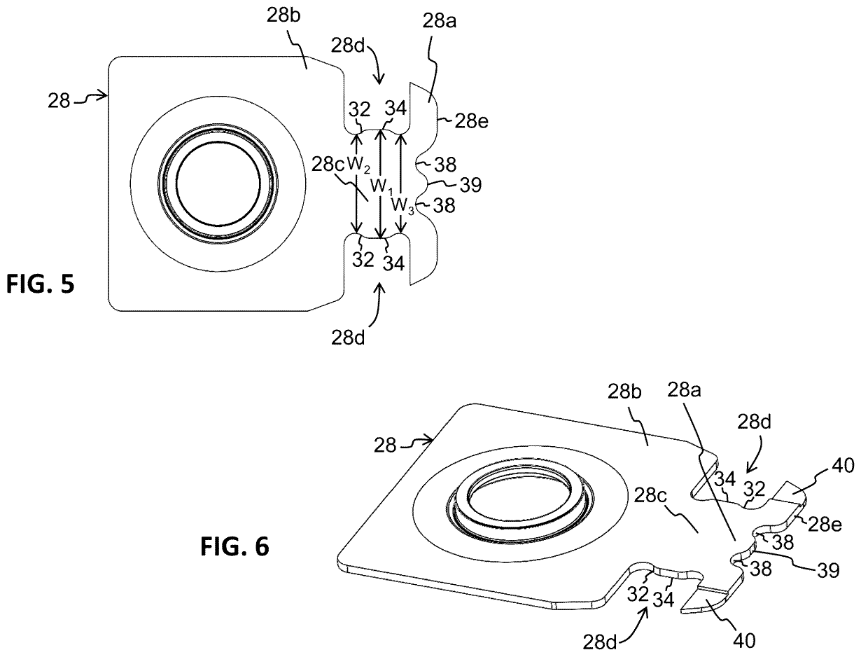

FIG. 5 illustrates a second example of the base plate 28, which is the same as the base plate 28 in FIGS. 3-4, except the distal edge 28e includes two notches 38 with a protrusion 39 between the two notches 38. It has been discovered by the present inventor that this example base plate provides a slightly lower sway frequency, but slightly higher stroke sensitivity, than that provided by the example of FIGS. 3-4.

FIG. 6 illustrates a third example of the base plate 28, which is the same as the base plate 28 in FIG. 5, except the distal portion 28a includes two thin portions 40. Specifically, the distal portion 28a has a first thickness except for the two thin portions 40 which have a second thickness less than the first thickness. The two thin portions 40 are disposed along the distal edge 28e, and the two notches 38 and protrusion 39 are disposed between the two thin portions 40. It has been discovered by the present inventor that this example base plate provides a slightly higher sway frequency, but essentially the same stroke sensitivity, than that provided by the example of FIGS. 3-4.

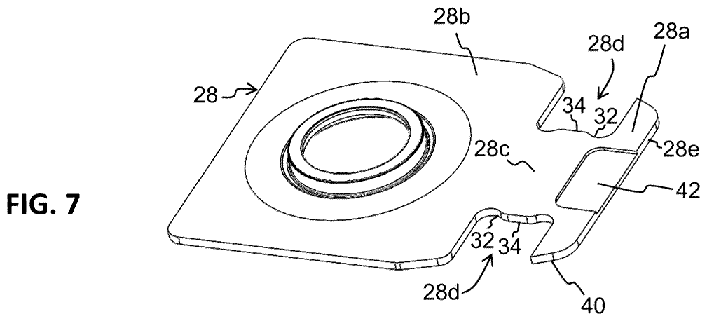

FIG. 7 illustrates a fourth example of the base plate 28, which is the same as the base plate 28 in FIGS. 3-4, except the notch 36 is omitted, and instead the distal portion 28a includes a thin portion 42. Specifically, the distal portion 28a has a first thickness except for the thin portion 42 which has a second thickness less than the first thickness. The thin portion 42 is disposed along a center portion of the distal edge 28e. It has been discovered by the present inventor that this example base plate provides a slightly higher sway frequency, but slightly lower stroke sensitivity, than that provided by the example of FIGS. 3-4.

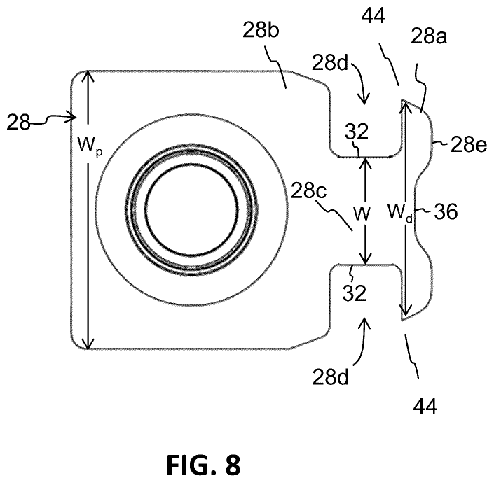

FIG. 8 illustrates a fifth example of the base plate 28, which is the same as the base plate 28 in FIGS. 3-4, except the protrusions 34 are omitted. In this example, the side edges 32 of neck portion 28c are straight, so that the neck portion 28c has a uniform width W. The advantage of this embodiment is that notch 36 provides higher sway frequency, but the straight side edges 32 of neck portion 28c make it easier to manufacture base plate 28.

Another advantage of this embodiment that contributes to the higher sway frequency is that the area of the distal portion 28a is additionally reduced by rounding the distal edge 28e so that it terminates in two sharp corners 44 (i.e., the notch 36 of the distal edge 28e is disposed between the two sharp corners 44 of the distal edge 28e), and by the distal portion 28a having a first width W_{d} that is less than the second width Wₚ of the proximal portion 28b.

It is to be understood that the present disclosure is not limited to the example(s) described above and illustrated herein, but encompasses any and all variations falling within the scope of any claims. References to the present disclosure or invention or examples herein are not intended to limit the scope of any claim or claim term, but instead merely make reference to one or more features that may be covered by one or more claims. Materials, processes and numerical examples described above are exemplary only, and should not be deemed to limit the claims.

Finally, any feature of one of the examples of FIGS. 3-7 can be combined with any of the features of the other examples. For example, improved performance can be obtained by combining the protrusions 34 of neck portion 28c with any one or more of the following: the notch 36, the notches 38 and protrusion 39, the thin portions 40 and the thin portion 42.

What is claimed is:

1. A suspension assembly comprising:
a load beam including a proximal end terminating in a hinge;
a gimbal assembly mounted to the load beam;
a base plate comprising:
a distal portion connected to the hinge,
a proximal portion, and
a neck portion disposed between the distal portion and the proximal portion,
wherein the neck portion comprising side edges facing away from each other,
wherein the side edges, the distal portion and the proximal portion define openings,
wherein each of the side edges includes a protrusion at a center of the neck portion facing one of the openings; and
PZT actuators each disposed in one of the openings and mounted to the proximal portion and the distal portion.

2. The suspension assembly of claim 1, wherein the neck portion comprises:
a first width at the center of the neck portion,
a second width adjacent the proximal portion,
a third width adjacent the distal portion, and
the first width is greater than the second width and the third width.

3. The suspension assembly of claim 1, wherein each of the protrusions is bonded to one of the PZT actuators.

4. The suspension assembly of claim 1, wherein the distal portion includes a distal edge facing away from the proximal portion, and wherein the distal edge includes a notch.

5. The suspension assembly of claim 1, wherein the distal portion includes a distal edge facing away from the proximal portion, and wherein the distal edge includes two notches.

6. The suspension assembly of claim 5, wherein the distal edge includes a protrusion disposed between the two notches.

7. The suspension assembly of claim 5, wherein the distal portion has a first thickness except for two thin portions of the distal portion which have a second thickness less than the first thickness, and wherein the two notches are disposed between the two thin portions.

8. The suspension assembly of claim 1, wherein the distal portion comprises:
a distal edge facing away from the proximal portion; and
a first thickness except for two thin portions of the distal portion which have a second thickness less than the first thickness, wherein the two thin portions are disposed along the distal edge.

9. The suspension assembly of claim 1, wherein the distal portion comprises:
a distal edge facing away from the proximal portion; and
a first thickness except for a thin portion of the distal portion which has a second thickness less than the first thickness, wherein the thin portion is disposed along the distal edge.

10. The suspension assembly of claim 9, wherein the thin portion is disposed along a center portion of the distal edge.

11. A suspension assembly comprising:
a load beam including a proximal end terminating in a hinge;
a gimbal assembly mounted to the load beam;
a base plate comprising:
a distal portion connected to the hinge,
a proximal portion, and
a neck portion disposed between the distal portion and the proximal portion,
wherein the neck portion comprising side edges facing away from each other,
wherein the side edges, the distal portion and the proximal portion define openings,
wherein the distal portion includes a distal edge facing away from the proximal portion,
wherein the distal edge includes a notch; and
PZT actuators each disposed in one of the openings and mounted to the proximal portion and the distal portion.

12. The suspension assembly of claim 11, wherein the neck portion has a uniform width.

13. The suspension assembly of claim 11, wherein the side edges are straight.

14. The suspension assembly of claim 11, wherein the distal edge terminates in two sharp corners.

15. The suspension assembly of claim 14, wherein the notch is disposed between the two sharp corners.

16. The suspension assembly of claim 11, wherein:
the distal portion has a first width;
the proximal portion has a second width; and
the first width is less than the second width.

17. The suspension assembly of claim 14, wherein:
the distal portion has a first width;
the proximal portion has a second width; and
the first width is less than the second width.
